(19) United States
(12) Patent Application Publication
(10) Pub. No.: US 2002/0012005 A1
(43) Pub. Date: Jan. 31, 2002

(54) Method and system for providing globalized color matching capabilities

(76) Inventors: Jerome Forest Parmer JR., Southington, CT (US); Dennis J. Yon, Slingerlands, NY (US)

Correspondence Address: Thomas M. Blasey, Esq., Hunton & Williams, Suite 1200, 1900 K Street, N.W., Washington, DC, 20006, US

(21) Appl. No.: 09/750,919

(22) Filed: Jan. 2, 2001

Related U.S. Application Data
(60) Provisional application No. 60/173,701, filed on Dec. 30, 1999.

(51) Int. Cl. G09G 5/02

(52) U.S. Cl. 345/600

(57) ABSTRACT

A method and system for providing globalized, uniform color matching capabilities to geographically distributed entities. Color match request (CMR) information is received. In response, the computer system electronically notifies a color matcher about the CMR program. Once the color matcher has completed his/her tasks, the system receives a color match formulation from the color matcher. The system then electronically notifies the color technician about the matcher's formulation. The system then receives a determination as to whether a sample in accordance with the matcher's results was approved by the customer. If not, the technician and matcher are so notified and the CMR is returned to the color matcher for reformulation. If the customer approves the sample, the CMR program is updated within the system to a complete status and, simultaneously, the color formula is updated to a customer approved status. If the customer fails to respond to the sample, the system next receives a determination as to whether the program should be canceled or approved internally. If the formula is to be approved internally, the CMR program is updated within the system to complete status and, the color formula is updated to internally approved. If the formula is rejected internally, the CMR program is closed and the status is changed within the system to canceled, customer rejected.

### CROSS REFERENCE TO RELATED APPLICATIONS

This application claims the benefit of provisional patent application Ser. No. 60/173,701, filed Dec. 30, 1999, the disclosure of which is incorporated herein by reference.

### BACKGROUND OF THE INVENTION

The present invention relates generally to systems and methods for providing comprehensive and consistent information across distributed working environments. More particularly, the present invention relates to plastics manufacturing organizations and a method for providing globalized, uniform color matching capabilities to distributed entities within the organization.

Conventionally, distributed global plastics manufacturing and design organizations have struggled to efficiently meet customer requests for color matching of manufacturer products. Because of inherent differences in both site development and requirements, conventional color matching introduction processes generally evolve differently at each site, thereby requiring time consuming translation and searching across the different sites in order to avoid inconsistent or redundant determinations. In addition to problems caused by the distributed nature of the organization, the sheer number of materials for which the colors are developed (on the order of tens of thousands) also increases the time burden on color matching capabilities. Because color matching requests are conventionally handles on an ad hoc basis, there is generally no way to efficiently research prior practices.

In addition to delays caused by redundant processing and the lack of research capabilities, additional delays are inserted by conventional paper shuffling. In conventional systems, prior to being manufactured a color match request must be initiated by a technician, delivered to a color matcher, who, provided he has all the information he needs, makes an initial color match formulation. This is then sent back to the technician who sends a sample based upon the formulation to the customer for review. If the sample is approved, the technician must deliver the formulation to a quality assurance representative who ensures that the formulation is not in violation of any restrictions or regulations. Each of these independent steps takes time and the transfer of responsibility from one entity to another adds to the duration and confusion of the project.

Therefore, there is a need in the art of plastics manufacturing and design organizations for a comprehensive systems to facilitate the matching of colors requested by customer. There is a further need for a method and system for providing globalized, automated processing of color match requests across distributed locations.

### BRIEF SUMMARY OF THE INVENTION

The present invention overcomes the problems noted above, and provides additional advantages, by providing a comprehensive system for providing globalized, uniform color matching capabilities to geographically distributed entities. In response to either a customer driven or internal request, a computer program application for implementing the method and system of the present invention receives a request to open a color match request (CMR) program. Once the program has been opened, the system receives CMR initialization information and then, upon user selection, launches a color match workflow selection. The system, in response to this selection, determines whether all required information was received. If not, the system informs the user that required information was missing and enables them to supply the missing information. If all information was received, the computer system electronically notifies a color matcher about the CMR program. Once the color matcher has completed his/her tasks, the system receives a color match formulation from the color matcher. The system then electronically notifies the color technician about the matcher's formulation. A sample in accordance with the matcher's results is then sent to the customer for approval. The system then receives a determination as to whether the sample was approved by the customer or not. If not, the technician and matcher are so notified and the CMR is returned to the color matcher for re-formulation.

However, if the customer approves the sample, the CMR program is updated within the system to a complete status and, simultaneously, the color formula is updated to customer approved status. If the customer fails to respond to the sample, the system next receives a determination as to whether the program should be canceled or approved internally. If the formula is to be approved internally, the CMR program is updated within the system to complete status and, the color formula is updated to internally approved. If the formula is rejected internally, the CMR program is closed and the status is changed within the system to canceled, customer rejected.

By providing a uniform method of processing CMR's, the system of the present invention enables the streamlined matching of color requests. Further, by providing a single global system of record, the present invention improves the ability for users to search for pre-existing color matches and similar programs, thereby further increasing the speed and accuracy of the match.

### BRIEF DESCRIPTION OF THE DRAWINGS

The present invention can be understood more completely by reading the following Detailed Description of exemplary embodiments, in conjunction with the accompanying drawings, in which:

FIG. 1 is a flow chart describing a preferred general embodiment of a method for providing color matching capabilities to distributed entities;

FIG. 2 is a flow chart describing a preferred method for facilitating progression through a first stage in a CMR process;

FIG. 3 is a flow chart describing a preferred method for facilitating progression through a second stage in a CMR process;

FIG. 4 is a flow chart describing a preferred method for facilitating progression through a third stage in a CMR process;

FIG. 5 is a flow chart describing a preferred method for facilitating progression through a fourth stage in a CMR process; and

FIG. 6 is a flow chart describing one embodiment for searching stored CMR or other product design programs to determine the need for a new CMR.

### DETAILED DESCRIPTION OF THE INVENTION

The system and method of the present invention described below, are preferably implemented by an interactive computer software system incorporated within a computer-readable medium such as a hard disk drive, an optical medium such as a compact disk, or the like. Further, the medium is preferably available to a plurality of distributed users connected together over a computer network, such as a local area network (LAN), a wide area network (WAN), or the Internet. The inventive computer software system is designed to receive a plurality of color matching related information from a plurality of project participants. The application then facilitates the analysis, distribution, and implementation of this information so as to provide rapid color matching capabilities as well as an accurate and complete repository for all color matching requests and resulting formulations.

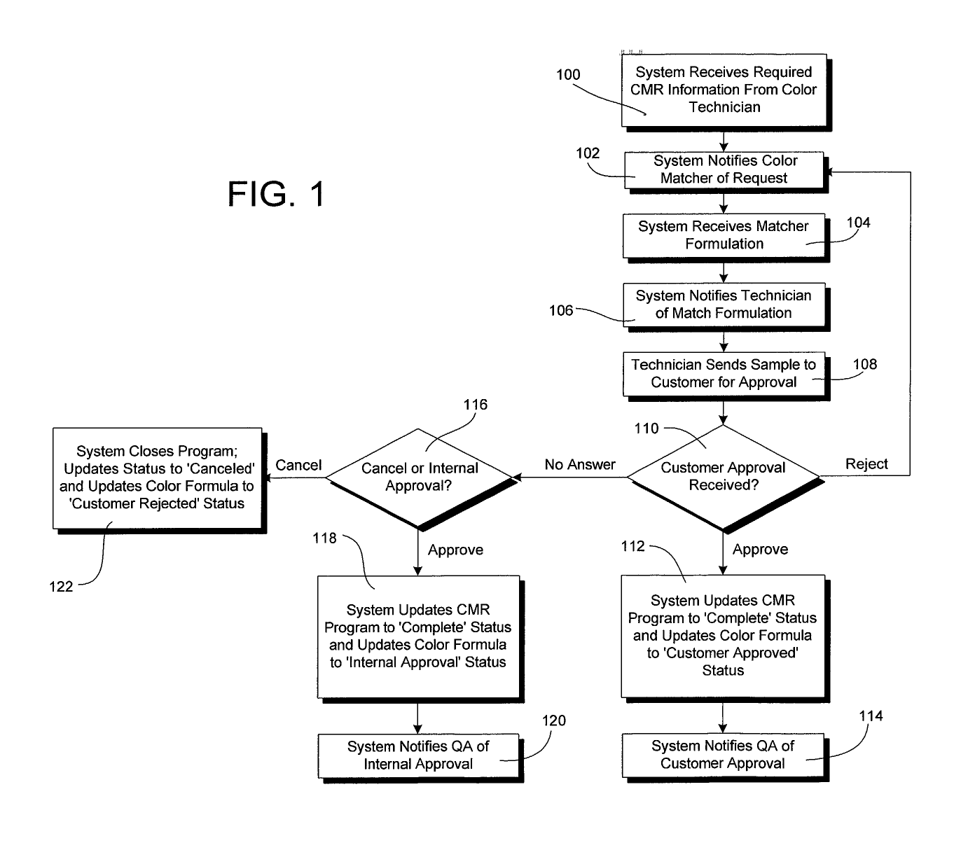

Referring to the Figures and, in particular, to FIG. 1, there is shown a flow chart describing a preferred general embodiment of a method for providing color matching capabilities to distributed entities. In a first step 100, a color technician opens a Color Match Request (CMR) in the computer software system. As will be described in additional detail below, the processing of opening a CMR program requires the submission of a variety of CMR information related to the specific matching request such as a customer identity, any critical color requirements, and the grade of material that needs to be formulated into the matched color.

Once all required CMR information has been received and stored, the system, in step 102, notifies a color matcher about the CMR program, and requests that the matcher review the received CMR information and make the appropriate color match. At this point, the status of the CMR program is updated to ‘Pending’. It should be understood, that while a particular individual may be notified in step 102, a more practical method is to notify a group of matchers about the CMR, thereby more easily facilitating the match by any member of the group. This methodology substantially reduces CMR turnaround time. In response to the match request, the color matcher, typically in a laboratory environment, formulates the appropriate color match for the selected grade. The specifics of the system will be described in additional detail below, however it should be understood that the CMR computer system substantially simplifies the color matching process by providing comprehensive cross-referencing capabilities. By storing information on all CMRs which may be globally searched in a variety of manners, the present system enables color matchers and technicians to search prior CMR's to see if either the current match request has been made before, or if a similar match has been made, thereby providing a better starting point for the present match.

Once the color matcher has completed the match formulation, he submits the formulation to the computer system in step 104. In a preferred embodiment, the color match formula is created in a stand alone, proprietary computer system. Following formula creation, the formula is exported into a easily understood format such as XML understood by those skilled in the art. Once in XML format, the formula and any information included therewith is easily imported and saved into the present computer system, thereby making it available for review by all participants in the CMR process.

In step 106, the system notifies the color technician responsible for the particular CMR program that the matcher has submitted a color match formulation. In response to this notice, the technician sends a sample of the color formulation to the customer for review and approval in step 108. After the customer has reviewed the sample, the system, in step 110, receives an indication from the technician as to whether the sample was approved, rejected, or whether the customer failed to respond. If the sample was rejected by the customer, the CMR is sent back to the color matcher in step 102, with instructions to try again. Preferably, the return of the CMR is accompanied by any comments received from the customer relating to why the match was rejected. If the sample was approved by the customer, the system proceeds to step 112, where the status of the CMR program is updated to ‘Complete’. Simultaneously, the color formulation approved by the customer is updated to ‘Customer Approved’ status. In step 114, the system notifies the organization's quality assurance group that the color match formulation has been approved by the customer. Upon review by a QA representative, the match formulation is exported to the legacy manufacturing systems for use in meeting production demands for the customer.

If, in step 110, the system receives a ‘no answer’ indication from the technician, the system proceeds to step 116 where it receives an indication from the technician as to whether the match formulation will be approved internally or canceled. If the match formulation is to be approved internally, the system proceeds to step 118, where the status of the CMR program is updated to ‘Complete’ and the color formulation status is updated to ‘Internal Approval’. In step 120, the system notifies the organization's quality assurance group that the color match formulation has been approved internally. Upon review by a QA representative, the match formulation is exported to the legacy manufacturing systems for use in meeting production demands for the customer. If it is determined that the CMR program should be canceled, either through a failure to match the color or loss of interest either on the part of the customer or internally, the system proceeds to step 122, where the program status is updated to ‘Canceled’ and the match formulation status is updated to ‘Customer Rejected’. At this point, the present CMR program is ended. However, because of the storing and searching capabilities of the present invention, the program may be reviewed in connection with a future CMR program so as to substantially reduce the amount of redundant work being done.

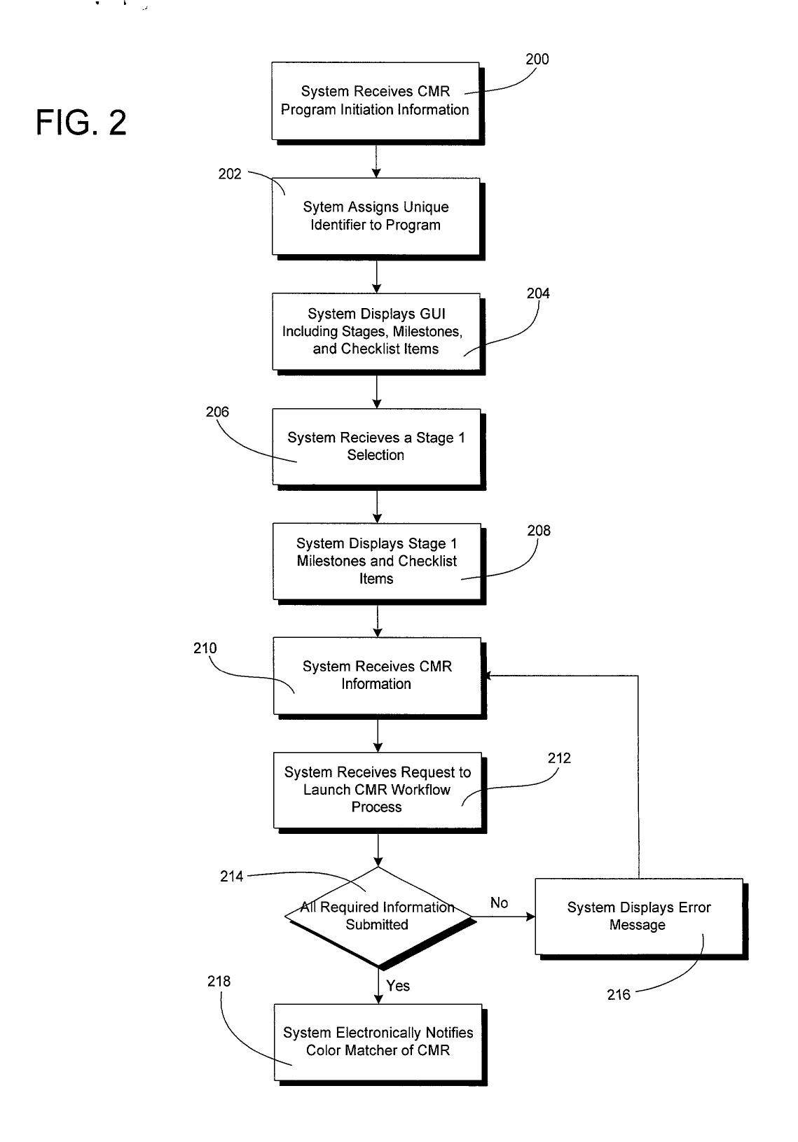

Referring now to FIG. 2, there is shown a flow chart describing a preferred method for facilitating progression through a first stage in a CMR process. In step 200, the computer system described above receives CMR program initiation information from the color technician developer. Preferably, this information includes an identification of the site requesting the CMR, as well as the product line and type related to the request. Additionally, the initiation information may also include a program owner and a brief description of the color match request. In step 202, the computer system automatically assigns a unique identifier to the program so that all information collected may be easily stored together and subsequently retrieved. In step 204, the computer system displays a graphical user interface (GUI) including a plurality of stages, milestones, and checklist items. As will be set forth in additional detail below, the stages, milestones and checklist items form a hierarchical breakdown of the various tasks which must be completed in managing a CMR.

In a preferred embodiment, a CMR program includes at least four stages: stage 1 relating to initiation of the CMR program; stage 2 relating to making a color match; stage 3 relating to sending a match sample to the customer and receiving an associated approval or rejection; and stage 4 relating to internally signing off on the match and exporting the approved formulation to legacy manufacturing systems. Each of the above stages includes a plurality of milestones corresponding to principal elements of the stage. Likewise, each milestone preferably includes a variety of checklist items related to the associated milestone. By following each checklist, the appropriate user is easily directed through the proper, universal, process for completing the CMR program.

In step 206, the system receives a color technician selection of stage 1. In step 208, the system, using GUI briefly described above, displays the various milestones and checklist items associated with stage 1. In a preferred embodiment, stage 1 includes at least one milestone directed toward receiving CMR information required prior to sending the CMR to a color matcher. A plurality of corresponding checklist items are related to the specific information needed. In a preferred embodiment, the system includes checklist items related to: 1) defining the grade formula; 2) defining the color formula; 3) defining the customer for whom the match is requested; and 4) defining the color CTQ's (criticals to quality) required by the customer.

In step 210, the system receives CMR information from the color technician related to the above-described checklist items. In a preferred embodiment, the receipt of CMR information is facilitated by a plurality of user-defined fields related to reference type, reference information, and comments. Upon selection of a particular checklist item, the technician can select a suitable reference type describing the type of information being attached. Then, in the reference field, the technician can insert the required information. Further, if the technician does not immediately know the reference information to be submitted, a preferred embodiment of the system provides a lookup feature that enables the technician to look up the information to be submitted. Similarly, the technician may attach any ancillary information that may be useful to the matcher in making the color match using the comments field. In this manner, the technician progresses through each of the checklist items displayed in step 208 and submits the required information in step 210.

In step 212, the system receives a technician request to launch a CMR workflow process. Preferably, this request includes a selection of a particular color matcher or group of color matchers as well as a customer response representative and a quality assurance representative responsible for the CMR. Upon receipt of this request, the system, in step 214, checks the information received in step 210 to ensure that all required information has been properly received. If all required information has not been properly received, the system, in step 216, displays an error message to the technician indicating what information is missing and returns the technician to step 208 for submission of this information. If all information has been properly received, the system, in step 218 electronically notifies the selected color matcher of the CMR and updates the status of the CMR program to ‘Pending’.

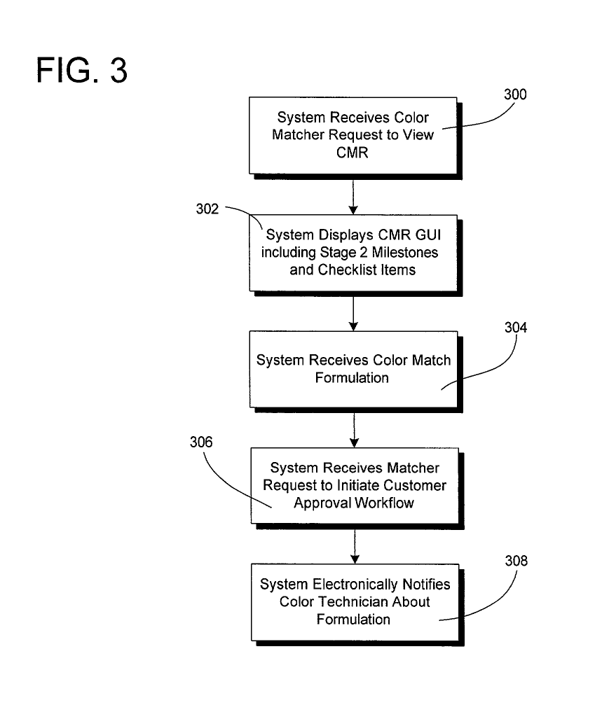

Referring now to FIG. 3, there is shown a flow chart describing a preferred method for facilitating progression through the second stage in the CMR process. As set forth above, stage 2 of the CMR process relates to tasks completed by a color matcher in making the match formulation and importing this formulation into the computer system for subsequent review and approval by the customer. In step 300, the system receives a request from a color matcher to review a selected CMR program which they have been notified about. In step 302, the system displays that above-described GUI illustrating the various stage 2 milestones and checklist items. In a preferred embodiment, stage 2 includes at least one milestone relating to conducting the CMR workflow. This milestone preferably includes a plurality of checklist items leading the color matcher through this process. In step 304, the system receives a color match formulation from the color matcher. As briefly described above, this formula may be created in the present system or, alternatively, imported from a stand alone software application.

In step 306, the system receives a color matcher request to initiate a customer approval workflow. In response, the system electronically notifies the color technician that the color match has been completed and that a sample needs to be sent to the customer for review and approval.

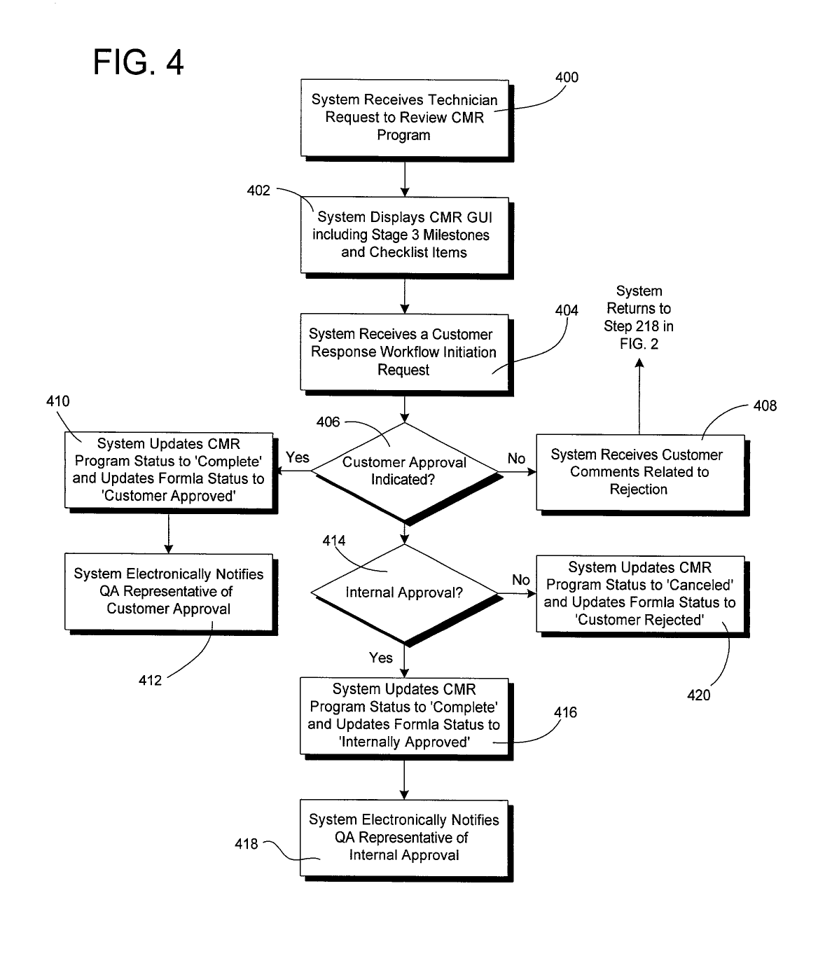

Referring now to FIG. 4, there is shown a flow chart describing a preferred method for facilitating progression through the third stage in the CMR process. As set forth above, stage 3 of the CMR process relates to tasks completed by a color technician in sending a sample of the color match to the customer and the associated approval or rejection of the match. In step 400, the system receives a request from a color technician to review the CMR program which they have been notified about. In step 402, the system displays that above-described GUI illustrating the various stage 3 milestones and checklist items. In a preferred embodiment, stage 3 includes at least one milestone relating to sending a sample to the customer and receiving approval or rejection of the sample. This milestone preferably includes a plurality of checklist items leading the color technician through this process. At this point, the color technician, using the guidelines set forth as checklist items, sends a sample of the color match to the customer for approval or rejection. In step 404, the system receives a customer response workflow initiation request. In step 406, the system, as part of the customer response workflow, receives an indication from the color technician that the sample was either approved, rejection, or a response was not forthcoming.

If, in step 406, the system received an indication that the sample was rejected, the system receives, in step 408, any comments associated with the rejection and, returns the color match formulation from the color matcher in step 218 of FIG. 2. As briefly described above, this formula may be created in the present system or, alternatively, imported from a stand alone software application. If, in step 406, the system received an indication that the sample was approved by the customer, the system, in step 410, updates the status of the CMR program to ‘Complete’ and updates the status of the match formulation to ‘Customer Approved’. Simultaneously, in step 412, the system electronically notifies a quality assurance representative that the match formulation has been approved by the customer.

If, in step 406, the system received an indication that no response was received from the customer, the system next receives, in step 414, a determination as to whether or not to internally approved the match formulation or to cancel the program. If a determination to internally approve the match formulation is received, the system, in step 416, updates the status of the CMR program to ‘Complete’ and updates the status of the match formulation to ‘Internally Approved’. Simultaneously, in step 418, the system electronically notifies a quality assurance representative that the match formulation has been approved internally. However, if the system receives a determination to cancel the program, the system, in step 420, updates the status of the CMR program to ‘Canceled’ and further updates the status of the match formulation to ‘Customer Rejected Status’.

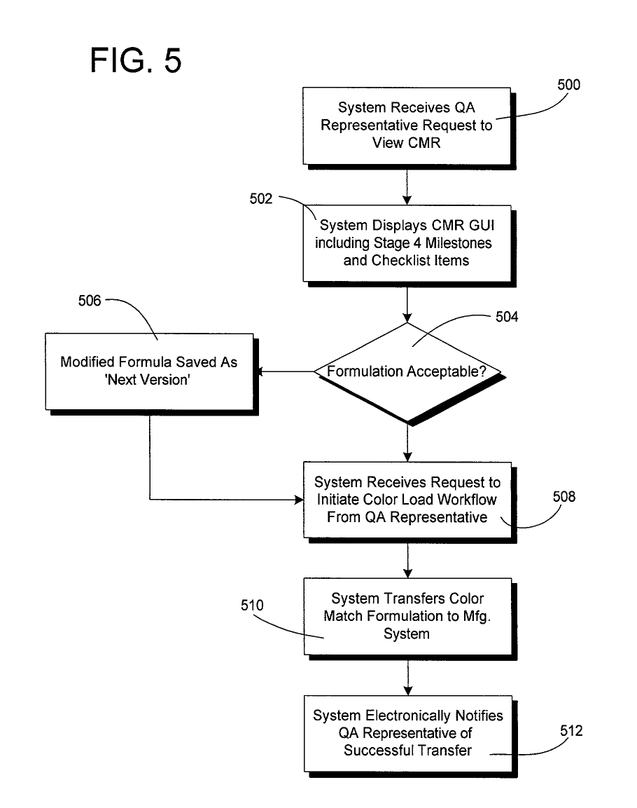

Referring now to FIG. 5, there is shown a flow chart describing a preferred method for facilitating progression through the fourth stage in the CMR process. As set forth above, stage 4 of the CMR process relates to tasks completed by a quality assurance representative in ensuring that the customer or internally approved match formulation does not conflict with existing material use restrictions for the selected facility. In step 500, the system receives a request from a quality assurance representative to review the CMR program which they have been notified about. In step 502, the system displays the above-described GUI illustrating the various stage 4 milestones and checklist items. In a preferred embodiment, stage 4 includes at least one milestone relating to approving a color match formulation and uploading the formula into the legacy systems for subsequent use in manufacturing. This milestone preferably includes a plurality of checklist items leading the quality assurance representative through this process.

At this point, the system receives in step 504 a determination from the quality assurance representative as to whether the ‘Customer or Internally Approved’ formulation is acceptable or must be modified in view of any facility restrictions that may exist. If the system receives an indication that the formulation must be modified, a modified formula is saved as a ‘Next Version” in step 506. However, if the existing formulation is acceptable, the system, in step 508, receives an approval from the quality assurance representative in the form of an load color workflow initiation. In a preferred embodiment, only an authorized quality assurance representative can initiate a load color workflow, thereby preventing the unauthorized manufacture of unapproved color match formulations. In step 510, the system transfers the color match formulation and any ancillary information to the organization's manufacturing system for use in subsequent productions. Once the transfer has been successfully made, the system, in step 512, electronically notifies the quality assurance representative of the successful transfer.

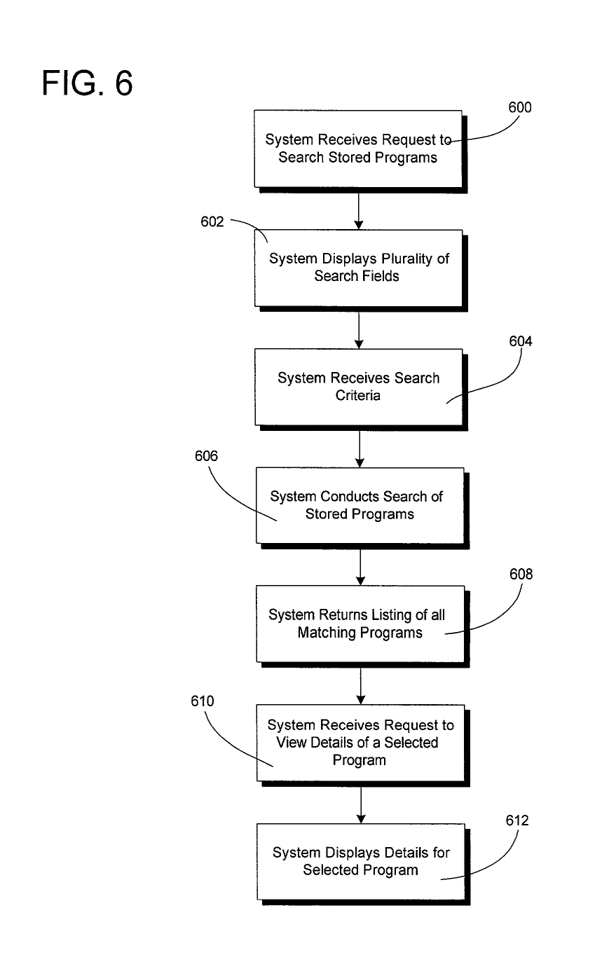

Because the system of the present invention provides a global repository for a variety of color-related information, entries in the system are subsequently valuable as reference materials for future color match requests. Referring now to FIG. 6, there is disclosed a flow chart describing one embodiment for searching stored CMR or other product design programs to determine the need for a new CMR. In step 600, the system receives a user request to search for a stored CMR program. In step 602, the system displays a plurality of search code fields relating to searchable information in each CMR. In a preferred embodiment, examples of searchable fields include: customer name; type of program; CTQ values; _{Δ}L, _{Δ}a, and _{Δ}b values (color related quantities); spectral values; end use; product line; etc.

In step 604, the system receives any submitted search criteria and, in step 606, conducts a search of all stored CMR and other product design programs. In step 608, the system displays a listing of all programs which met the received criteria. In step 610, the system receives, a user request to view the details of a particular program displayed in the listing of step 608. In response, the system, in step 612, displays a detailed description of the selected program. Any information which was attached to the program during pendency is also available at this time.

By providing a uniform process for providing globalized color matching capabilities, the system of the present invention, substantially solves the problems involved with conventional color matching system. Because all color matching programs in every location must be introduced in accordance with the above system, added consistency results. In addition to consistency, the above-described invention further provides for a uniform system of record for all color match requests that is subsequently searchable as a reference tool. Consequently, future developers may search the system to determine if similar work had been done in the past. Further, because of the computer-based nature of the inventive system, transitions between stages are streamlined through electronic notifications and file attachments. This effectively reduces the turnaround time previously required to match a color upon customer request.

While the foregoing description includes many details and specificities, it is to be understood that these have been included for purposes of explanation only, and are not to be interpreted as limitations of the present invention. Many modifications to the embodiments described above can be made without departing from the spirit and scope of the invention, as is intended to be encompassed by the following claims and their legal equivalents.

What is claimed is:

1. A method for providing globalized color matching capabilities, comprising the steps of:
receiving a first set of information relating to a color match request from a first user;
storing the first set of information in a database of color match requests;
electronically notifying a second user about the need to perform a color match;
receiving a color match formulation from the second user;
storing the color match formulation in the database of color match requests.
electronically notifying the first user about the color match formulation;
receiving a customer approval determination from the first user regarding a sample sent to the customer using the color match formulation;
electronically notifying the second user about the need to retry the color match if the customer approval determination indicates that the customer rejected the sample;
updating a color match request status to ‘Complete’ if the customer approval determination indicates that the customer approved the sample;
receiving an internal approval determination from the first user regarding an internal decision to approve the color match formulation if the customer approval determination indicates that the customer did not respond to the sample;
updating a color match request status to ‘Complete’ if the internal approval determination indicates that the color match formulation was internally approved;
updating a color match request status to ‘Canceled’ if the internal approval determination indicates that the color match formulation should be canceled; and
electronically transmitting the color match formulation to a manufacturing system for use in manufacturing products if the status of the color match request is ‘Complete’.

2. The method of claim 1, further comprising the steps of:
receiving a second set of information relating to initialization of a color match request program;
assigning a unique program identifier to the first set of information and the second set of information; and
storing the second set of information in the database of color match requests.

3. The method of claim 1, wherein the step of receiving a first set of information relating to a color match request from a first user further comprises the steps of:
receiving color CTQ information related to critical requirements of the color match formulation;
receiving customer identification information related to the customer requesting the color match;
receiving material grade formula information related a specific material whose color is to be matched; and
receiving color formulation information related to a specific color formulation to be used in the color match.

4. The method of claim 1, further comprising the steps of:
determining whether all required information relating to the color match request has been received;
displaying an error message to the first user if it is determined that all required information relating to the color match request has not been received; and
receiving any required information that was not initially received.

5. The method of claim 1, further comprising the steps of:
updating a status of the color match formulation to ‘Customer Approved’ if the customer approval determination indicates that the customer approved the sample;
updating a status of the color match formulation to ‘Internally Approved’ if the internal approval determination indicates that the sample was internally approved; and
updating a status of the color match formulation to ‘Customer Rejected’ if the internal approval determination indicates that the color match formulation should be canceled.

6. The method of claim 1, further comprising the steps of:
electronically notifying a quality assurance representative if the status of the color match formulation is ‘Customer Approved’ or ‘Internally Approved’;
receiving an approval determination from the quality assurance representative regarding whether or not to transfer the color match formulation to the manufacturing system for use in manufacturing products;
electronically transferring the color match formulation to the manufacturing system if the approval determination indicates that the color match formulation is acceptable.

7. The method of claim 5, further comprising the steps of:
receiving a modified color match formulation from the quality assurance representative;
storing the modified color match formulation; and
electronically transferring the modified color match formulation to the manufacturing system.

8. A method for providing globalized color matching capabilities, comprising the steps of:
receiving a first set of information relating to a color match request from a first user;
electronically notifying a second user about the need to perform a color match;
receiving a color match formulation from the second user;
electronically notifying the first user about the received color match formulation;
electronically notifying the second user about the need to retry the color match if it is determined that the color match formulation does not meet a customer's requirements; and
updating a color match request status to ‘Complete’ if it is determined that the color match formulation meets the customer's requirements.

9. A computer readable medium for incorporating instructions for providing globalized color matching capabilities, the instructions comprising:
one or more instructions for receiving a first set of information relating to a color match request from a first user;
one or more instructions for storing the first set of information in a database of color match requests;
one or more instructions for electronically notifying a second user about the need to perform a color match;
one or more instructions for receiving a color match formulation from the second user;
one or more instructions for storing the color match formulation in the database of color match requests.
one or more instructions for electronically notifying the first user about the color match formulation;
one or more instructions for receiving a customer approval determination from the first user regarding a sample sent to the customer using the color match formulation;
one or more instructions for electronically notifying the second user about the need to retry the color match if the customer approval determination indicates that the customer rejected the sample;
one or more instructions for updating a color match request status to ‘Complete’ if the customer approval determination indicates that the customer approved the sample;
one or more instructions for receiving an internal approval determination from the first user regarding an internal decision to approve the color match formulation if the customer approval determination indicates that the customer did not respond to the sample;
one or more instructions for updating a color match request status to ‘Complete’ if the internal approval determination indicates that the color match formulation was internally approved;
one or more instructions for updating a color match request status to ‘Canceled’ if the internal approval determination indicates that the color match formulation should be canceled; and
one or more instructions for electronically transmitting the color match formulation to a manufacturing system for use in manufacturing products if the status of the color match request is ‘Complete’.

10. The computer readable storage medium of claim 9, further comprising:
one or more instructions for receiving a second set of information relating to initialization of a color match request program;
one or more instructions for assigning a unique program identifier to the first set of information and the second set of information; and
one or more instructions for storing the second set of information in the database of color match requests.

11. The computer readable storage medium of claim 9, wherein the one or more instructions for receiving a first set of information relating to a color match request from a first user further comprise:
one or more instructions for receiving color CTQ information related to critical requirements of the color match formulation;
one or more instructions for receiving customer identification information related to the customer requesting the color match;
one or more instructions for receiving material grade formula information related a specific material whose color is to be matched; and
one or more instructions for receiving color formulation information related to a specific color formulation to be used in the color match.

12. The computer readable storage medium of claim 9, further comprising:
one or more instructions for determining whether all required information relating to the color match request has been received;
one or more instructions for displaying an error message to the first user if it is determined that all required information relating to the color match request has not been received; and
one or more instructions for receiving any required information that was not initially received.

13. The computer readable storage medium of claim 9, further comprising:
one or more instructions for updating a status of the color match formulation to ‘Customer Approved’ if the customer approval determination indicates that the customer approved the sample;
one or more instructions for updating a status of the color match formulation to ‘Internally Approved’ if the internal approval determination indicates that the sample was internally approved; and
one or more instructions for updating a status of the color match formulation to ‘Customer Rejected’ if the internal approval determination indicates that the color match formulation should be canceled.

14. The computer readable storage medium of claim 9, further comprising:
one or more instructions for electronically notifying a quality assurance representative if the status of the color match formulation is ‘Customer Approved’ or ‘Internally Approved’;
one or more instructions for receiving an approval determination from the quality assurance representative regarding whether or not to transfer the color match formulation to the manufacturing system for use in manufacturing products;
one or more instructions for electronically transferring the color match formulation to the manufacturing system if the approval determination indicates that the color match formulation is acceptable.

15. The computer readable storage medium of claim 13, further comprising:
one or more instructions for receiving a modified color match formulation from the quality assurance representative;
one or more instructions for storing the modified color match formulation; and
one or more instructions for electronically transferring the modified color match formulation to the manufacturing system.

16. A computer readable medium for incorporating instructions for providing globalized color matching capabilities, the instructions comprising:
one or more instructions for receiving a first set of information relating to a color match request from a first user;
one or more instructions for electronically notifying a second user about the need to perform a color match;
one or more instructions for receiving a color match formulation from the second user;
one or more instructions for electronically notifying the first user about the received color match formulation;
one or more instructions for electronically notifying the second user about the need to retry the color match if it is determined that the color match formulation does not meet a customer's requirements; and
one or more instructions for updating a color match request status to ‘Complete’ if it is determined that the color match formulation meets the customer's requirements.
